(19) United States
(12) Patent Application Publication
(10) Pub. No.: US 2016/0141580 A1
(43) Pub. Date: May 19, 2016

(54) ALKALI-ION CONDUCTIVE SEPARATOR ASSEMBLY FOR RECHARGEABLE ELECTROCHEMICAL CELLS

(71) Applicant: BASF SE, Ludwigshafen (DE)

(72) Inventors: Heino SOMMER, Eggenstein-Leopoldshafen (DE); Jochen REINACHER, Giessen (DE); Juergen JANEK, Giessen (DE); Stefan BERENDTS, Giessen (DE)

(73) Assignee: BASF SE, Ludwigshafen (DE)

(21) Appl. No.: 14/899,899

(22) PCT Filed: May 27, 2014
(86) PCT No.: PCT/IB2014/061752

§ 371 Date: Dec. 18, 2015

(30) Foreign Application Priority Data
Jun. 19, 2013 (EP) 13172768.7

(51) Int. Cl. H01M 2/16; H01M 10/0525; H01M 2/14

(52) U.S. Cl. CPC H01M 2/1686; H01M 2/145; H01M 2/1646; H01M 10/0525; H01M 2220/20

(57) ABSTRACT

Disclosed is an alkali-ion conducting separator assembly comprising a porous membrane (A) and an alkali-ion conducting film (B) placed on one major surface of the porous membrane (A), wherein the alkali-ion conducting film (B) comprises an inorganic material of the general formula (I): (L¹⁺_{[(12-u)2+wv)-xm-[(3-y)3+yn]-[(2-z)5+zp]}I^{m+}ₓ](A³⁺_{3-y}aⁿ⁺_{y})(B⁵⁺_{2-z}b^{p+}_{z})(O²⁻₁₂₋ᵤD^{v-}_{w}) (I) Further disclosed is a process for producing such an alkali-ion conducting separator assembly and a rechargeable electrochemical cell comprising such an alkali-ion conducting separator assembly.

The present invention relates to an alkali-ion conducting separator assembly comprising a porous membrane (A) and an alkali-ion conducting film (B) placed on one major surface of the porous membrane (A), wherein the alkali-ion conducting film (B) comprises an inorganic material of the general formula (I):

(L¹⁺_{[(12-u)2+wv]-xm-[(3-y)3+yn]-[(2-z)5+zp]}I^{m+}ₓ)(A³⁺_{3-y}aⁿ⁺_{y})(B⁵⁺_{2-z}b^{p+}_{z})(O²⁻₁₂₋ᵤD^{v-}_{w}) (I).

The present invention further relates to a process for producing such an alkali-ion conducting separator assembly and to a rechargeable electrochemical cell comprising such an alkali-ion conducting separator assembly.

Secondary batteries, accumulators or “rechargeable batteries” are just some embodiments by which electrical energy can be stored after generation and used when required. Owing to the significantly better power density, there has in recent times been a move away from the water-based secondary batteries toward development of those batteries in which the charge transport in the electrical cell is accomplished by lithium ions.

However, the energy density of conventional lithium ion accumulators which have a carbon anode and a cathode based on metal oxides is limited. New horizons with regard to energy density have been opened up by lithium-sulfur cells and by alkali metal-oxygen cells. In lithium-sulfur cells, sulfur is reduced in the sulfur cathode via polysulfide ions to S²⁻ which on charging of the cell is reoxidized to form sulfur-sulfur bonds. In alkali metal-oxygen cells an alkali metal like lithium or sodium is oxidized with atmospheric oxygen in a non-aqueous electrolyte to form an oxide, a peroxide or a superoxide, i.e., to form Li₂O or Li₂O₂ while in the course of charging the oxide, peroxide or superoxide ions are oxidized to oxygen.

In electrochemical cells, the positively and negatively charged electrode compositions are mechanically separated from one another by layers which are not electrically conductive, known as separators, to avoid internal discharge. Due to their microporous structure many commonly used separators like polymer membranes or nonwovens do not only allow the transport of positive ionic charges like lithium cations as basic prerequisite for continuing offtake of current during operation of the electrochemical cell but also open the unwanted migration of polysulfide ions or reducible charged oxygen species from the cathode to the metal anode. In order to avoid these parasitic processes alternative separators have been discussed. Solid lithium electrolytes like solid Li-ion conductors have been proposed and investigated as separators in electrochemical cells. Basic requirements, which such separators have to meet, are chemical and electrochemical stability toward both the active electrode compositions, resistance to dendrite growth and high cell temperatures, impermeability for mobile electrode components and liquid electrolyte components, and high ion conductivity even at room temperature and below.

WO 2005/085138 and WO2009/003695 describe several ion conductors having a garnet structure.

Abstract #316, 223rd. ECS Meeting 2013 describes aluminum migration during deposition of Li₇La₃Zr₂O₁₂ thin films on aluminum oxide substrates.

U.S. Pat. No. 8,323,817 describes a galvanic cell comprising a water-impermeable, alkali-ion-conductive ceramic membrane as separator.

US 2012/0270112 describes a composite solid electrolyte that includes a monolithic solid electrolyte base component that is a continuous matrix of an inorganic active metal ion conductor and a filler component used to eliminate through porosity in the solid electrolyte.

WO2012/013603 describes an inorganic electrolyte membrane, wherein that membrane is a porous membrane made of an electrically insulating metal or metalloid oxide having throughpores or through-channels, which are open at the ends and wherein an electrolyte is confined within the pores of the membrane.

The separators known from the literature, which comprise alkali-ion conducting materials, still have deficiencies in respect of one or more of the properties desired for such separators, for example low thickness, low weight per unit area, good mechanical stability during processing or in operation of the battery in respect of metal dendrite growth, good heat resistance, good ion conductivity and complete impermeability for organic solvents. Some of the deficiencies of the known separators are ultimately responsible for a reduced life or limited performance of the electrochemical cells comprising them. Furthermore, separators in principle have to be not only mechanically but also chemically stable toward the cathode materials, the anode materials and the electrolytes. In the field of lithium-sulfur cells, separators which also prevent early cell death of lithium-sulfur cells, which is brought about particularly by migration of polysulfide ions from the cathode to the anode, are desirable.

It was therefore an object of the invention to provide an inexpensive separator for a long-lived electrochemical cell, in particular a lithium-sulfur cell or an alkali metal-oxygen cell, which has advantages in respect of one or more properties of a known separator, in particular a separator which displays sufficient ion conductivity, high thermal stability and good mechanical properties.

This object is achieved by an alkali-ion conducting separator assembly comprising
(A) a porous membrane (A), which consists of at least one inorganic, electrically insulating and non-alkali-ion conducting material, having through pores that extend from one major surface of the membrane to an opposing major surface, and
(B) an alkali-ion conducting film (B) placed on one major surface of the porous membrane (A),
   wherein the through pores of the porous membrane (A) are sealed by the alkali-ion conducting film (B), wherein the alkali-ion conducting film (B) comprises an inorganic material of the general formula (I)

(L¹⁺_{[(12-u)2+wv]-xm-[(3-y)3+yn]-[(2-z)5+zp]}I^{m+}ₓ)(A³⁺_{3-y}aⁿ⁺_{y})(B⁵⁺_{2-z}b^{p+}_{z})(O²⁻₁₂₋ᵤD^{v-}_{w}) (I)

in which the variables are each defined as follows:
L is an alkali metal, like Li, Na or K, preferably Li,
I is Mg, Al or Ga, preferably Al,
A is a lanthanide, preferably La,
a is an alkali metal, alkaline earth metal or a lanthanide, preferably Ba,
B is Nb or Ta, preferably Ta,
b is Nb, Ta, Zr, Hf, Ce, Y, W, Mo, Sb, Te, Bi, Sn, Ti or Pr, preferably Zr,
D is F (fluorine), S (sulfur), N (nitrogen) or C (carbon),

### m is 2 for Mg or 3 for Al or Ga,

n is 1 for alkali metal, 2 for alkaline earth metal or 2, 3 or 4 for lanthanide,
p is 2, 3, 4, 5 or 6 depending on the oxidation state of metal b,
is 1 for F (fluorine), 2 for S (sulfur), 3 for N (nitrogen) or 4 for C (carbon),
w is in the range from 0 to 12, preferably in the range from 0 to 6, in particular 0 to 3,
u is in the range from 0 to 12, preferably in the range from 0 to wv/2, in particular wv/2,
x is in the range from 0 to 0.75, preferably in the range from 0.25 to 0.35, in particular 0.29,
y is in the range from 0 to 3, preferably in the range from 0 to 1,
z is in the range from 0 to 2, preferably in the range from 0.5 to 1.75.

Examples of a lanthanide are La, Ce, Pr, Nd, Sm, Eu, Gd, Tb, Dy, Ho, Er, Tm, Yb or Lu.

The inventive alkali-ion conducting separator assembly comprises at least two layers that means at least one porous membrane (A) and at least one alkali-ion conducting film (B) as described above. The thickness of the inventive alkali-ion conducting separator assembly can be varied in a wide range. Preferably the inventive alkali-ion conducting separator assembly has an average thickness in the range from 1 to 1000 μm, preferably in the range from 5 to 500 μm, in particular in the range from 5 to 100 μm.

The inventive alkali-ion conducting separator assembly preferably consists of one porous membrane (A) that is sealed on one side with one or more, preferably with one alkali-ion conducting film (B).

The porous membrane (A), which consists of at least one inorganic, electrically insulating and non-alkali-ion conducting material, has through pores that extend from one major surface of membrane (A) to an opposing major surface. The porous membrane (A) itself is electrically insulating. Preferably the porous membrane (A) consists of one inorganic, electrically insulating and non-alkali-ion conducting material.

In the context of the present invention the expression “electrically insulating” means, that the electrical conductivity of the material is less than 10⁻⁸ S/cm at 25° C.

The inorganic, electrically insulating and non-alkali-ion conducting material can be chosen from a wide range of suitable materials known to the person skilled in the art. A preferred material is selected from the group consisting of ceramics, sintered ceramics, glass-ceramics and glasses, preferably ceramics. Preferred ceramics are chosen from the group consisting of SiO₂, Al₂O₃, MgO, MgAl₂O₄, TiO₂, ZrO₂, SiC and Si₃N₄, preferably SiO₂, Al₂O₃ and MgO, particularly preferred SiO₂ and Al₂O₃, in particular Al₂O₃.

In one embodiment of the present invention the alkali-ion conducting separator assembly is characterized in that the inorganic, electrically insulating and non-alkali-ion conducting material of the porous membrane (A) is selected from the group consisting of ceramics, sintered ceramics, glass-ceramics and glasses, preferably ceramics, in particular anodically oxidized aluminum (anodized aluminum oxide (AAO), Al₂O₃).

The formation of controlled-porosity membranes from anodically oxidized aluminum (AAO) is known to the person skilled in the art.

The thickness of the porous membrane (A) can be varied in a wide range. Preferably the porous membrane (A) has an average thickness in the range from 1 to 1000 μm, preferably in the range from 5 to 500 μm, in particular in the range from 5 to 100 μm.

In one embodiment of the present invention the alkali-ion conducting separator assembly is characterized in that the porous membrane (A) has an average thickness in the range from 5 to 500 μm.

The average diameter of the through pores of the porous membrane (A) can be varied in a wide range. Preferably the average diameter of the through pores is in the range from 0.01 to 100 μm, preferably in the range from 0.02 to 10 μm, in particular in the range from 0.04 to 0.4 μm.

The porosity of the porous membrane (A) can be varied in a wide range. Preferably the porosity of the porous membrane (A) is in the range from 10 to 90%, more preferably in the range from 15 to 75%, in particular in the range from 20 to 60% by volume based on the total volume of the membrane.

The alkali-ion conducting film (B), which is placed on one major surface of the porous membrane (A), in order to seal the through pores of the porous membrane (A), comprises an inorganic material of the general formula (I) as described above.

Particularly preferred is an inorganic material of the general formula (I) wherein

L is Li, I is Al, A is La, a is Ba, B is Ta, b is Zr, m is 3, n is 2, p is 4, x is in the range from 0 to 0.75, y is in the range from 0 to 3, z is in the range from 0 to 2, w is 0 and u is 0.

Examples of preferred compounds are for example Li₆BaLa₂Ta₂O₁₂, Li_{5.755}Al_{0.29}La₃Ta_{0.375}Zr_{1.625}O₁₂ or Li_{6.5}La₃Ta_{0.5}Zr_{1.5}O₁₂.

The preparation of the inorganic materials of the general formula (I) is known to the person skilled in the art and is for example described in WO 2005/085138 or WO2009/003695.

The thickness of the alkali-ion conducting film (B) can be varied in a wide range. Preferably the alkali-ion conducting film (B) has an average thickness in the range from 0.01 to 1000 μm, preferably in the range from 0.01 to 40 μm, in particular in the range from 0.05 to 4 μm.

In one embodiment of the present invention the alkali-ion conducting separator assembly is characterized in that the alkali-ion conducting film (B) has an average thickness in the range from 0.01 to 40 μm, preferably in the range from 0.05 to 4 μm.

Preferably the alkali-ion conducting film (B) consists of at least 80% by weight, preferably at least 90% by weight, in particular in the range from 95% to 100% by weight of at least one, preferably one or two, in particular one inorganic material of the general formula (I).

The thickness of the porous membrane (A) and of the alkali-ion conducting film (B) as well as the average diameter of the through pores of the porous membrane (A) can be determined according to Scanning Electron Microscopy (SEM, cross section analysis) or Transmission Electron Microscopy (TEM) measurement.

While the porous membrane (A) itself is permeable to organic solvents the alkali-ion conducting film (B) is impermeable to organic solvents. Therefore the alkali-ion conducting separator assembly is also impermeable to organic solvents.

In one embodiment of the present invention the alkali-ion conducting separator assembly is characterized in that the alkali-ion conducting separator assembly is impermeable to organic solvents.

The present invention further provides a process for producing an alkali-ion conducting separator assembly comprising
(A) a porous membrane (A), which consists of at least one inorganic, electrically insulating and non-alkali-ion conducting material, having through pores that extend from one major surface of the membrane to an opposing major surface, and
(B) an alkali-ion conducting film (B) placed on one major surface of the porous membrane (A),
   wherein the through pores of the porous membrane (A) are sealed by the alkali-ion conducting film (B), wherein the alkali-ion conducting film (B) comprises an inorganic material of the general formula (I)

(L¹⁺_{[(12-u)2+wv]-xm-[(3-y)3+yn]-[(2-z)5+zp]}I^{m+}ₓ)(A³⁺_{3-y}aⁿ⁺_{y})(B⁵⁺_{2-z}b^{p+}_{z})(O²⁻₁₂₋ᵤD^{v-}_{w}) (I)

in which the variables are each defined as follows:
L is an alkali metal, like Li, Na or K, preferably Li,
I is Mg, Al or Ga, preferably Al,
A is a lanthanide, preferably La,
a is an alkali metal, alkaline earth metal or a lanthanide, preferably Ba,
B is Nb or Ta, preferably Ta,
b is Nb, Ta, Zr, Hf, Ce, Y, W, Mo, Sb, Te, Bi, Sn, Ti or Pr, preferably Zr,
D is F (fluorine), S (sulfur), N (nitrogen) or C (carbon),

### m is 2 for Mg or 3 for Al or Ga,

n is 1 for alkali metal, 2 for alkaline earth metal or 2, 3 or 4 for lanthanide,
p is 2, 3, 4, 5 or 6 depending on the oxidation state of metal b,
is 1 for F (fluorine), 2 for S (sulfur), 3 for N (nitrogen) or 4 for C (carbon),
w is in the range from 0 to 12, preferably in the range from 0 to 6, in particular 0 to 3,
u is in the range from 0 to 12, preferably in the range from 0 to wv/2, in particular wv/2,
x is in the range from 0 to 0.75, preferably in the range from 0.25 to 0.35, in particular 0.29,
y is in the range from 0 to 3, preferably in the range from 0 to 1,
z is in the range from 0 to 2, preferably in the range from 0.5 to 1.75,
comprising the process step of
(a) depositing a layer of a material, which is alkali-ion conducting or which becomes alkali-ion conducting after thermal or chemical, preferably thermal treatment, on one major surface of a porous membrane (A), which consists of inorganic, electrically insulating and non-alkali-ion conducting material, having through pores that extend from one major surface of the membrane to an opposing major surface, and
(b) optionally calcination of the porous membrane with the deposited layer formed in process step (a) in a temperature range from 100° C. to 1500° C., preferably in a temperature range from 500 to 900° C.

The description and preferred embodiments of the alkali-ion conducting separator assembly and its components, in particular the description of the porous membrane (A) as a first component and of the alkali-ion conducting film (B) as a second component, in the process of the invention correspond to the above description of these components for the alkali-ion conducting separator assembly of the invention.

In process step (a) a layer of a material, which is alkali-ion conducting or which becomes alkali-ion conducting after thermal or chemical, preferably thermal treatment, is deposited on one major surface of a porous membrane (A), which consists of inorganic, electrically insulating and non-alkali-ion conducting material, having through pores that extend from one major surface of the membrane to an opposing major surface.

The layer of the material, which is alkali-ion conducting or which becomes alkali-ion conducting after thermal or chemical, preferably thermal treatment, preferably comprises at least one inorganic material of the general formula (I):

(L¹⁺_{[(12-u)2+wv]-xm-[(3-y)3+yn]-[(2-z)5+zp]}I^{m+}ₓ)(A³⁺_{3-y}aⁿ⁺_{y})(B⁵⁺_{2-z}b^{p+}_{z})(O²⁻₁₂₋ᵤD^{v-}_{w}) (I)

as described above. The description and preferred embodiments of the variables and the indices of formula (I) correspond to the above description of the inorganic material of formula (I). It is also possible to deposit two or more different inorganic materials of the general formula (I) either together or one after the other on one surface of membrane (A). Preferably the layer of the material consists of at least 80% by weight, preferably at least 90% by weight, in particular in the range from 95% to 100% by weight of at least one, preferably one or two, in particular one inorganic material of the general formula (I).

The person skilled in the art is aware of different methods to deposit inorganic materials in form of a film on a surface of an inorganic target. Preferred deposition methods are pulsed laser deposition (PLD), physical vapor deposition (PVD), chemical vapor deposition (CVD), sputter techniques or (spray) casting methods (spraying/dip coating/sol-gel). A particularly preferred deposition method is pulsed laser deposition (PLD).

In one embodiment of the present invention the inventive process is characterized in that in process step (a) the material, which is alkali-ion conducting or which becomes alkali-ion conducting after thermal or chemical, preferably thermal treatment, is deposited on the surface of the porous membrane (A) by pulsed laser deposition (PLD).

The deposited layer of the material, which is alkali-ion conducting or which becomes alkali-ion conducting after thermal or chemical, preferably thermal treatment, forms a film, that is alkali-ion conducting or becomes alkali-ion conducting after thermal or chemical, in particular thermal treatment, and that seals the through pores of the porous membrane (A) on one major surface of said membrane (A).

In the optional process step (b) the porous membrane with the deposited layer formed in process step (a) is calcined in a temperature range from 100° C. to 1500° C., preferably in a temperature range from 500° C. to 900° C. The calcination step can remove possible inhomogeneities in the layer of the material which are caused by the deposition method and might convert the deposited material from a non-alkali-ion conducting form to an alkali-ion conducting form. Inhomogeneities can be related to differences in the thickness or to the evenness of the layer or to the chemical or structural composition of the layer. The calcination step might for example also convert the crystal structure of the deposited material.

Alternatively the deposited layer formed in process step (a) can be treated chemically in order to modify the deposited material. Possible methods of chemical treatment of the deposited layer include gas phase reactions (e.g. N₂, NH₃, N_{y}Oₓ, H₂S, H₂O, O₂, H₂, F₂, HF, Cl₂, HCl and combinations of two or more aforementioned gases with defined partial pressures), reaction with molten chemical compounds or molten elements (e.g. (Li/Na)OH, (Li/Na)₂O, (Li/Na)NO₃ or Li/Na), reaction with evaporated chemical compounds or elements (e.g. Li₂O, Na₂O, Li or Na), reaction with in water or organic/ionic liquids dissolved alkali-ion containing (e.g. (Li/Na)OH, (Li/Na)₂O, (Li/Na)NO₃, (Li/Na)(B/Al)H₄) and/or alkali-ion free compounds (e.g. H₂O₂, N₂H₄, NH₃, HNO₃/HNO₂, H₂S, H₂SO₄, H₂SO₃), plasma treatment (e.g. O₂, N₂, H₂ or Ar/He and combinations of two or more aforementioned plasmas with defined pressures) and solid-solid reaction either of the deposited layer with the porous membrane (A), of two or more deposited material layers forming (B) or of an additionally deposited layer other than the composition stated in formula (I) with the material of (B) to modify the chemical composition and physico-chemical properties of (B).

The layer deposited in process step (a) and possibly further chemically or thermally treated forms the alkali-ion conducting film (B) of the inventive alkali-ion conducting separator assembly.

The inventive alkali-ion conducting separator assemblies are particularly suitable as separator or as constituent of a separator in electrochemical cells, in particular in rechargeable electrochemical cells.

For the purposes of the present invention, the term electrochemical cell or battery encompasses batteries, capacitors and accumulators (secondary batteries) of any type, in particular alkali metal cells or batteries such as lithium, lithium ion, lithium-sulfur, alkali metal-oxygen and alkaline earth metal batteries and accumulators, including in the form of high-energy or high-power systems, and also electrolyte capacitors and double-layer capacitors which are known under the names Supercaps, Goldcaps, BoostCaps or Ultracaps.

The present invention further provides a rechargeable electrochemical cell comprising at least one alkali-ion conducting separator assembly as described above.

The alkali-ion conducting separator assemblies of the invention are preferably suitable for electrochemical cells which are based on the transfer of alkali metal ions, in particular for lithium metal, lithium-sulfur, alkali metal-oxygen and lithium ion cells or batteries and especially for lithium ion secondary cells or secondary batteries. The alkali-ion conducting separator assemblies of the invention are particularly suitable for rechargeable electrochemical cells from the group of lithium-sulfur cells and alkali metal-oxygen cells.

The present invention further provides a rechargeable electrochemical cell comprising

(a) at least one cathode (a),
(b) at least one anode, preferably comprising at least one alkali metal,
(c) at least one electrolyte composition (c) comprising
(c1) at least one aprotic organic solvent (c1), and
(c2) at least one alkali metal salt (c2), and
   (d) at least one alkali-ion conducting separator assembly as described above.

As regards suitable cathode materials, suitable anode materials, suitable electrolytes and possible arrangements, reference is made to the relevant prior art, e.g. appropriate monographs and reference works: e.g. Wakihara et al. (editor): Lithium ion Batteries, 1^{st} edition, Wiley VCH, Weinheim, 1998; David Linden: Handbook of Batteries (McGraw-Hill Handbooks), 3^{rd} edition, Mcgraw-Hill Professional, New York 2008; J. O. Besenhard: Handbook of Battery Materials. Wiley-VCH, 1998.

In the context with the present invention, the electrode where during discharging a net positive charge occurs is called the cathode.

The inventive rechargeable electrochemical cell comprises at least one cathode (a). Possible cathodes are, in particular, cathodes in which the cathode material comprises a lithium-transition metal oxide, e.g. lithium-cobalt oxide, lithium-nickel oxide, lithium-cobalt-nickel oxide, lithium-manganese oxide (spinel), lithium-nickel-cobalt-aluminum oxide, lithium-nickel-cobaltmanganese oxide or lithium-vanadium oxide, a lithium sulfide or lithium polysulfide such as Li₂S, Li₂S₈, Li₂S₆, Li₂S₄ or Li₂S₃ or a lithium-transition metal phosphate such as lithium-iron phosphate as electroactive constituent. Cathode materials which comprise iodine, oxygen, sulfur and the like as electroactive constituent are also suitable. However, if materials comprising sulfur or polymers comprising polysulfide bridges are to be used as cathode materials, it has to be ensured that the anode is charged with Li⁰ before such an electrochemical cell can be discharged and recharged. For this purpose lithium can be directly deposited (e.g. vapor deposition preferably sputtering, thermal vapor deposition or pulsed laser deposition, in particular thermal vapor deposition) on the open surface of the alkali-ion conducting film (B), which is placed with its opposite surface on the porous membrane (A). Gas diffusion electrodes, which are permeable to oxidizing gases, in particular to molecular oxygen O₂, are known and used as cathodes in alkali metal-oxygen cells. The alkali-ion conducting separator assembly is preferably used in inventive rechargeable electrochemical cells, wherein the at least one cathode (a) comprises an electroactive chalcogen-containing material, preferably an oxygen- or sulfur-containing material, in particular elemental sulfur.

In one embodiment of the present invention the inventive rechargeable electrochemical cell is characterized in that the at least one cathode (a) comprises an electroactive chalcogen-containing material, preferably an oxygen- or sulfur-containing material, in particular elemental sulfur.

Cathode (a) may comprise one or further constituents. For example, cathode (a) may comprise carbon in an electrical conductive polymorph, for example selected from graphite, carbon black, carbon nanotubes, graphene or mixtures of at least two of the aforementioned substances.

In addition, cathode (a) may comprise one or more binders, for example one or more organic polymers. Suitable binders may be selected, for example, from those binders which are described in WO 2011/161598, page 6, line 28 to page 8, line 15, where the binder is referred to as polymer (C) or binder (C).

Particularly suitable binders for the cathode (a) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (a) may have further constituents customary per se, for example an output conductor, which may be configured in the form of a metal wire, metal grid, metal mesh, expanded metal, metal sheet or metal foil. Suitable metal foils are especially aluminum foils.

In one embodiment of the present invention, cathode (a) has a thickness in the range from 25 to 200 μm, preferably from 30 to 100 μm, based on the thickness without output conductor.

The inventive rechargeable electrochemical cell further comprises, as well as the inventive alkali-ion conducting separator assembly and the cathode (a), at least one anode (b).

In the context with the present invention, the electrode where during discharging a net negative charge occurs is called the anode.

In an embodiment of the present invention, anode (b) can be selected from among anodes composed of carbon, anodes comprising Sn or Si, anodes comprising lithium titanate of the formula Li₄₊ₓTi₅O₁₂ in which x is a numerical value from >0 to 3, and anodes comprising an alkali metal, preferably lithium or sodium, in particular lithium. Anodes composed of carbon can, for example, be selected from among hard carbon, soft carbon, graphene, graphite and in particular graphite, intercalated graphite and mixtures of two or more of the abovementioned carbons. Anodes comprising Sn or Si can, for example be selected from among nanoparticulate Si or Sn powder, Si or Sn fibers, carbon-Si or carbon-Sn composites and Si-metal or Sn-metal alloys. The alkali metal, preferably lithium or sodium, in particular lithium, may be present in the form of pure alkali metal or in the form of an alloy of an alkali metal with at least another metal or in the form of an alkali metal carbon intercalation compound. The alkali-ion conducting separator assembly is preferably used in inventive rechargeable electrochemical cells, wherein the at least one anode (b) comprises an alkali metal, preferably lithium or sodium, in particular lithium.

In one embodiment of the present invention the inventive rechargeable electrochemical cell is characterized in that the at least one anode (b) comprises an alkali metal, preferably lithium or sodium, in particular lithium. As described above it is possible to deposit lithium directly to the open surface of the alkali-ion conducting film (B) of the separator assembly for example by vapor deposition or similar techniques, in particular thermal vapor deposition or pulsed laser deposition, preferably thermal vapor deposition.

Apart from the electroactive constituents the anode (b) can also comprise further constituents, for example
electrically conductive or electroactive constituents such as carbon black, graphite, carbon fibers, carbon nanofibers, carbon nanotubes or electrically conductive polymers;
binders such as polyethylene oxide (PEO), cellulose, carboxymethylcellulose (CMC), polyethylene, polypropylene, polytetrafluoroethylene, polyacrylonitrile-methyl methacrylate, polyvinyl alcohol, polytetrafluoroethylene, styrene-butadiene copolymers, tetrafluoroethylene-hexafluoroethylene copolymers, polyvinylidene difluoride (PVdF), polyvinylidene difluoride-hexafluoropropylene copolymers (PVdF-HFP), tetrafluoroethylene-hexafluoropropylene copolymers, tetrafluoroethylene, perfluoroalkyl-vinyl ether copolymers, vinylidene fluoride-hexafluoropropylene copolymers, ethylene-tetrafluoroethylene copolymers, vinylidene fluoride-chlorotrifluoroethylene copolymers, ethylene-chlorofluoroethylene copolymers, ethylene-acrylic acid copolymers (with and without inclusion of lithium/sodium ions), ethylene-methacrylic acid copolymers (with and without inclusion of lithium/sodium ions), ethylene-methacrylic ester copolymers (with and without inclusion of lithium/sodium ions), polyimides and polyisobutene.

In addition, anode (b) may have further constituents customary per se, for example an output conductor which may be configured in the form of a metal wire, metal grid, metal mesh, expanded metal, or a metal foil or metal sheet. Suitable metal foils are especially copper foils.

In one embodiment of the present invention, anode (b) has a thickness in the range from 15 to 200 μm, preferably from 30 to 100 μm, based on the thickness without output conductor.

The inventive rechargeable electrochemical cell further comprises, as well as the inventive alkali-ion conducting separator assembly, the cathode (a) and the anode (b), at least one electrolyte composition (c) comprising

(c1) at least one aprotic organic solvent (c1), and
(c2) at least one alkali metal salt (c2).

Possible aprotic organic solvents (c1) may be liquid or solid at room temperature and are preferably liquid at room temperature. Solvents (c1) are preferably selected from polymers, cyclic or noncyclic ethers, cyclic or noncyclic acetals, cyclic or noncyclic organic carbonates and ionic liquids.

In one embodiment of the present invention the inventive rechargeable electrochemical cell is characterized in that the aprotic organic solvent (c1) is selected from polymers, cyclic or noncyclic ethers, noncyclic or cyclic acetals and cyclic or noncyclic organic carbonates.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

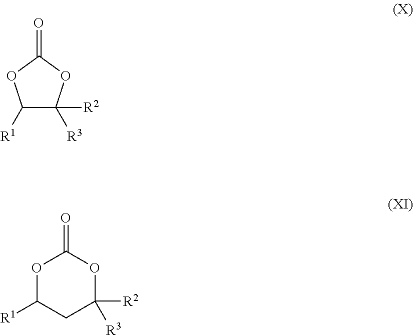

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

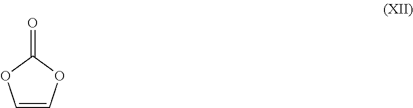

Preference is given to using the solvent(s) in what is called the anhydrous state, i.e. with a water content in the range from 1 ppm to 0.1% by weight, determinable, for example, by Karl Fischer titration.

Possible alkali metal salts (c2), which are used as conductive salts, have to be soluble in the aprotic organic solvent (c1). Preferred alkali metal salts (c2) are lithium salts or sodium salts, in particular lithium salts.

In one embodiment of the present invention the inventive rechargeable electrochemical cell is characterized in that wherein the alkali metal salt (c2) is a lithium salt or sodium salt, preferably a lithium salt.

Suitable alkali metal salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred alkali metal salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

The through pores of the porous membrane (A), which are open on the major side opposite to the sealing alkali-ion conducting film (B) can be filled either with suitable cathode materials, suitable anode materials or suitable electrolytes. Preferably the pores of the porous membrane (A) are filled with electrolyte composition (c) as described above.

In one embodiment of the present invention the inventive rechargeable electrochemical cell is characterized in that the alkali-ion conducting separator assembly comprises one porous, inorganic, non-alkali-ion conducting membrane (A) having through pores that extend from one major surface of the membrane to an opposing major surface, wherein an alkali-ion conducting film (B) is placed on one major surface of the porous, inorganic, non-alkali-ion conducting membrane (A) and the porous membrane (A) is filled with electrolyte composition (c).

Inventive rechargeable electrochemical cells further comprise a housing which may be of any shape, for example cuboidal or in the shape of a cylinder. In another embodiment, inventive rechargeable electrochemical cells have the shape of a prism. In one variant, the housing used is a metal-plastic composite film processed as a pouch.

The inventive rechargeable electrochemical cells can be assembled to rechargeable batteries, preferably rechargeable alkali metal ion batteries like lithium ion batteries, lithium sulfur batteries, lithium air batteries or sodium air batteries, in particular lithium sulfur batteries.

Accordingly, the present invention also further provides for the use of inventive rechargeable electrochemical cells as described above in rechargeable batteries, especially rechargeable lithium sulfur batteries.

The present invention further provides an alkali metal ion battery comprising at least one rechargeable electrochemical cell as described above. Inventive rechargeable electrochemical cells can be combined with one another in inventive alkali metal ion batteries, for example in series connection or in parallel connection. Series connection is preferred.

Inventive rechargeable electrochemical cells are notable for particularly high capacities, high performances even after repeated charging and greatly retarded cell death. Inventive rechargeable electrochemical cells are very suitable for use in motor vehicles, bicycles operated by electric motor (e.g. pedelecs), aircraft, ships and boats or stationary energy storage. Such uses form a further part of the subject matter of the present invention.

The present invention further provides for the use of inventive rechargeable electrochemical cells as described above in motor vehicles, bicycles operated by electric motor, aircraft, ships and boats or stationary energy storage.

The use of inventive rechargeable electrochemical cells in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore further provides for the use of inventive rechargeable electrochemical cells in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention further provides a device comprising at least one rechargeable electrochemical cell as described above.

The invention is illustrated by the examples which follow but do not restrict the invention.

Figures in percent are each based on % by weight, unless explicitly stated otherwise.

Li₆BaLa₂Ta₂O₁₂ as target material for pulsed laser deposition (PLD) was prepared by solid state reaction according to J. Awaka, N. Kijima, H. Hayakawa and J. Akimoto, Journal of Solid State Chemistry, 2009, 182, 2046.

I. Preparation of Alkali-Ion Conducting Separator Assemblies by Depositing a Film of Li₆BaLa₂Ta₂O₁₂ on Anodized Aluminum Oxide (AAO) Membrane

The deposition of lithium ion conducting garnet-type material on top of porous AAO was carried out by pulsed laser deposition (PLD). The PLD (Surface GmbH & Co. KG, Frankfurt am Main, Germany) was directly attached to an argon gas filled glove box (M. Braun GmbH, Garching, Germany) to avoid air contact of the samples. Li₆BaLa₂Ta₂O₁₂ was used as target. An AAO disc (Anopore™ inorganic membrane (Anodisc™) by Whatman plc, Maidstone, Kent, UK) with a diameter of 13 mm, average pore size of 100 nm and thickness of 60 μm was used as a substrate. A KrF Excimer Laser (Compex 201F, Coherent Inc., Santa Clara, Calif., USA) with a wavelength of 248 nm was used for the deposition of the garnet-type thin films. Prior to ablation the PLD chamber was evacuated to 1×10⁻⁵ mbar. The deposition process took place in pure 5×10⁻² mbar oxygen atmosphere (higher and lower pressure values were also possible, e.g. deposition at 2×10⁻² mbar oxygen atmosphere was also possible). The distance between target and substrate was set to 45 mm. It turned out, that this parameter (distance), which could be adjusted from 40 mm-85 mm, had little to no influence on the crystal structure of the deposited material but that it had a bigger influence on the deposition rate and film morphology. The substrate was attached to a metallic substrate holder by a mask with a hole of 12 mm and the substrate holder was heated to 840° C. by an IR-laser heater. However, this temperature is the temperature measured at the backside of the substrate holder with a Pyrometer and was not the surface temperature of the substrate. The surface temperature of the substrate was believed to be in the range from 500° C.-800° C. The type of heater, IR-Laser or any other type of heat source is not relevant. The laser fluence was adjusted in the range from 2 J/cm² to 4 J/cm². The laser frequency was adjusted to 10 Hz wherein the laser frequency has an influence on the deposition rate. The thin films had thicknesses between 0.5 μm and 3 μm.

### I.1 Alkali-Ion Conducting Separator Assembly SA.1

SA.1 was prepared as described in example I. with following parameters:
Substrate: AAO-disk from Whatman; diameter: 13 mm; pore sizes: 100 nm; thickness: 60 μm.
Target: Chemical composition: Li₆BaLa₂Ta₂O₁₂ (ICP-OES, EDS for Ba, La and Ta)
   Electrical conductivity: 6-7×10⁻⁷ S/cm (electrochemical impedance spectroscopy)
SA.1: Thickness of alkali-ion conducting film (B): 1 μm (SEM, cross-section)
   Diameter of alkali-ion conducting film (B): 12 mm (defined by mask)
   Morphology: dense and visually homogeneous (SEM, top-view) thin film
   Porosity: visually (SEM, cross-section and top-view) no open porosity
   Crystal structure: cubic garnet-type phase (XRD, preferred orientation)

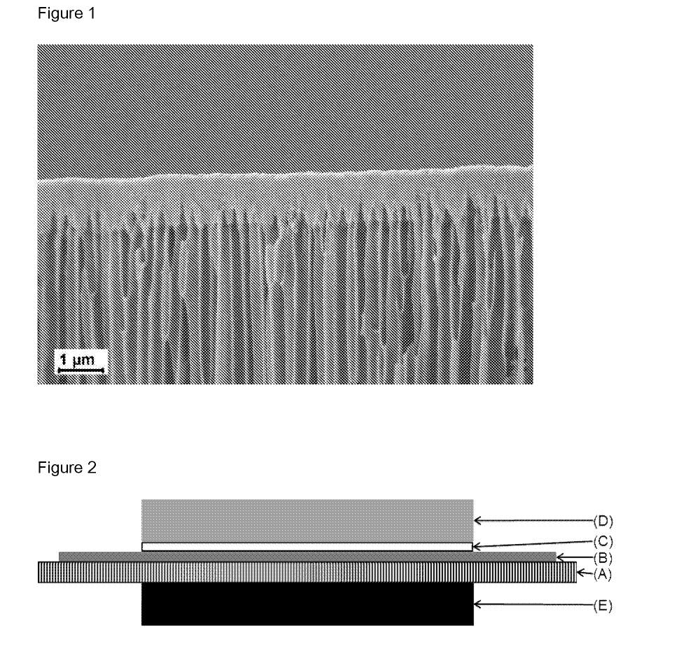

FIG. 1 shows a SEM cross-section of SA.1 (LBLTO on AAO)

### I.2 Alkali-Ion Conducting Separator Assembly SA.2

Experiment I. was repeated, except that Li_{6.5}La₃Zr_{1.5}Ta_{0.5}O₁₂ was used as target in place of Li₆BaLa₂Ta₂O₁₂ to produce alkali-ion conducting separator assembly SA.2. Li_{6.5}La₃Zr_{1.5}Ta_{0.5}O₁₂ was prepared according to J. Power Sources 2012, 236-244.

Substrate: AAO-disk from Whatman; diameter: 13 mm; pore sizes: 100 nm; thickness: 60 μm.

Target: Chemical composition: Li_{6.5}La₃Zr_{1.5}Ta_{0.5}O₁₂

### II. Electrochemical Testing of Alkali-Ion Conducting Separator Assemblies

### Cathode (a)

For the preparation of the cathodes (a) sulfur, conductive carbon additives (Printex XE2 (Orion) and Super C65 (TIMCAL™) in a ratio of 1:1) and poly(vinyl alcohol) (Aldrich) were mixed with mass ratio of 60:35:5 in water to form a slurry. The slurry was then coated onto aluminum foil (20 μm) with a doctor's blade and dried in vacuum at 40° C. for 16 h.

### Anode (b)

### Lithium Foil (China Lithium Ltd., 600 μm, 8 mm)

### Electrolyte (c)

The electrolyte was a solution of 12 wt % lithium bis(trifluromethanesulfonyl)imide (LiTFSI) (Aldrich, 99.95%), 44 wt % of 1,2-dimethoxyethane (DME) (Alfa Aesar, 99+%) and 44 wt % 1,3-dioxolane (DOL) (Acros, 99.8%). The electrolyte solvents were purified by distillation from sodium potassium alloy under argon atmosphere.

### II.1 Production of an Inventive Electrochemical Cell EC.1 and Testing

A coin-type cell was assembled in an argon-filled glovebox using a sulfur cathode (a) with an electrode diameter of 8 mm, the alkali-ion conducting separator assembly SA.1 produced according to 1.1 (diameter of (A) 13 mm and (B) 12 mm, respectively) and lithium foil (China Lithium Ltd., 600 μm, 8 mm) as negative electrode (anode (b)). Additionally a glass fiber separator (GF/A, Whatman) was placed between anode (b) and the Li-ion conductive film (B). The cathode electrode (a) was assembled on the opposite side of the Li-ion conductive film (B) and directly on the porous membrane (A). The glass fiber separator (C) and positive electrode (a) were soaked with electrolyte (c).

Discharge-charge cycling of the cell was performed at 0.036 mA (corresponds to a rate of C/50 for the used cathode electrode) for the first cycle with a discharge cutoff voltage of 1.7 V and charge cutoff at 2.5 V. For the subsequent cycles a discharge current of 0.36 mA, and charge current of 0.22 mA was applied. This corresponds to a discharge rate of C/5 and a charge rate of C/8 for this cell. The electrochemical experiments were carried out under controlled and constant environmental conditions.

FIG. 2 shows the schematic structure of the different layers of the electrochemical cell EC.1. The annotations in FIG. 2 mean:

(A) porous membrane (A)
(B) Li-ion conductive film (B)
(C) glass fiber separator (C)
(D) anode (b)
(E) cathode (a)

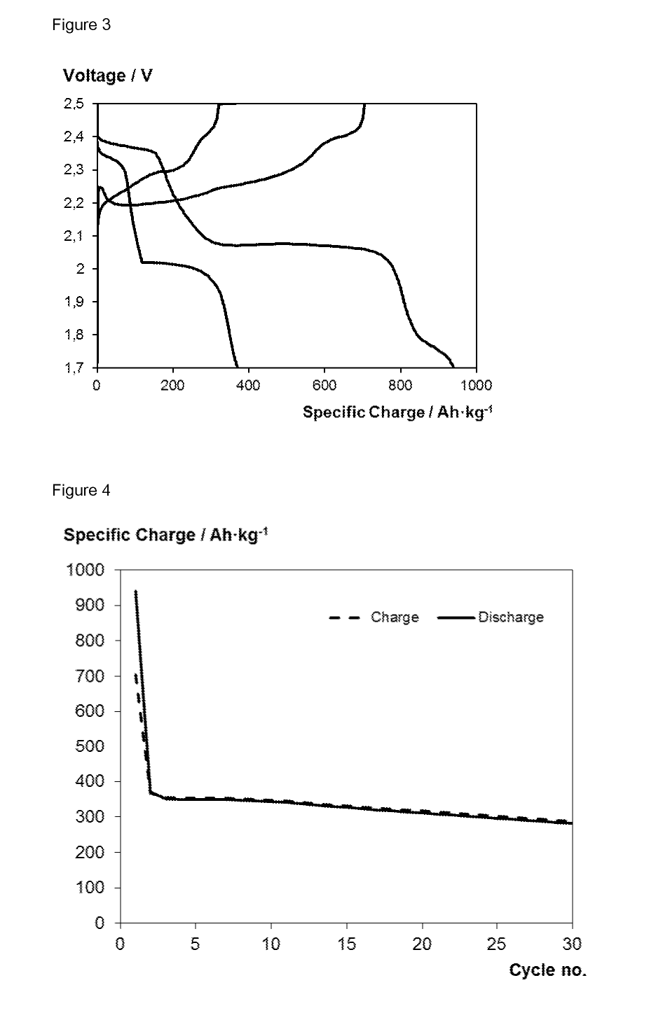

FIG. 3 shows the voltage profile of the Li/S cell EC.1. Plotted are the first cycle with an applied current of 0.036 mA for charge and discharge, and the second cycle with a discharged current of 0.36 mA and charge current of 0.22 mA.

FIG. 4 shows the electrochemical performance of the Li/S cell EC.1.

### II.2 Production of an Inventive Electrochemical Cell EC.2

A coin-type cell was assembled in an argon-filled glovebox using a sulfur cathode (a) with an electrode diameter of 8 mm and the alkali-ion conducting separator assembly SA.1 produced according to 1.1 (diameter of (A) 13 mm and (B) 12 mm, respectively), wherein a layer of lithium (F) has been deposited directly on the Li-ion conductive film (B) of the separator assembly SA.1 by thermal vapor deposition. The positive electrode (sulfur cathode (a)) was soaked with electrolyte while the compartment of the lithium deposited (F) membrane (A)+(B) contains no electrolyte.

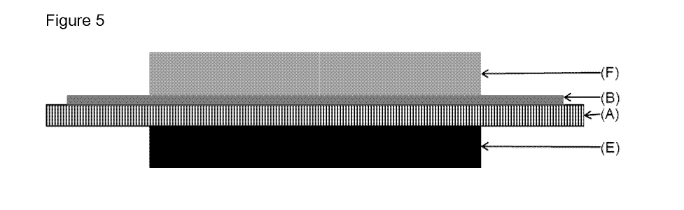

FIG. 5 shows the schematic structure of the different layers of the electrochemical cell EC.2. The annotations in FIG. 5 mean:

(A) porous membrane (A)
(B) Li-ion conductive film (B)
(F) anode (b)
(E) cathode (a)

1. An alkali-ion conducting separator assembly comprising:
a porous membrane comprising at least one inorganic, electrically insulating and non-alkali-ion conducting material, the porous membrane comprising through pores that extend from one major surface of the porous membrane to an opposing major surface, and
an alkali-ion conducting film placed on one major surface of the porous membrane;
wherein:
the through pores of the porous membrane are sealed by the alkali-ion conducting film, and
the alkali-ion conducting film comprises an inorganic material of the formula (I):
(L¹⁺_{[(12-u)2+wv]-xm-[(3-y)3+yn]-[(2-z)5+zp]}I^{m+}ₓ)(A³⁺_{3-y}aⁿ⁺_{y})(B⁵⁺_{2-z}b^{p+}_{z})(O²⁻₁₂₋ᵤD^{v-}_{w}) (I)
in which:
L is an alkali metal,
I is Mg, Al or Ga,
A is a lanthanide,
a is an alkali metal, alkaline earth metal or a lanthanide,
B is Nb or Ta,
b is Nb, Ta, Zr, Hf, Ce, Y, W, Mo, Sb, Te, Bi, Sn, Ti or Pr,
D is F (fluorine), S (sulfur), N (nitrogen) or C (carbon),
m is 2 for Mg or 3 for Al or Ga,
n is 1 for alkali metal, 2 for alkaline earth metal or 2, 3 or 4 for lanthanide,
p is 2, 3, 4, 5 or 6 depending on the oxidation state of metal b,
is 1 for F (fluorine), 2 for S (sulfur), 3 for N (nitrogen) or 4 for C (carbon),
w is in the range from 0 to 12,
u is in the range from 0 to 12,
x is in the range from 0 to 0.75,
y is in the range from 0 to 3, and
z is in the range from 0 to 2.

2. The alkali-ion conducting separator assembly according to claim 1, wherein the inorganic, electrically insulating and non-alkali-ion conducting material of the porous membrane is selected from the group consisting of a ceramic, a sintered ceramic, a glass ceramic and a glass.

3. The alkali-ion conducting separator assembly according to claim 1, wherein the porous membrane has an average thickness of 5 μm to 500 μm.

4. The alkali-ion conducting separator assembly according to claim 1, wherein the alkali-ion conducting film has an average thickness of 0.01 μm to 40 μm.

5. The alkali-ion conducting separator assembly according to claim 1, wherein the alkali-ion conducting separator assembly is impermeable to organic solvents.

6. A process for producing an alkali-ion conducting separator assembly according to claim 1, comprising:
depositing a layer of a material, which is alkali-ion conducting or which becomes alkali-ion conducting after thermal or chemical treatment, on one major surface of the porous membrane; and
optionally calcinating the porous membrane comprising the deposited layer at 100° C. to 1500° C.

7. A rechargeable electrochemical cell comprising:
at least one cathode,
at least one anode,
at least one electrolyte composition comprising:
at least one aprotic organic solvent, and
at least one alkali metal salt, and
at least one alkali-ion conducting separator assembly according to claim 1.

8. The rechargeable electrochemical cell according to claim 7, wherein the at least one cathode (a) comprises an electroactive chalcogen-containing material.

9. The rechargeable electrochemical cell according to claim 7, wherein the at least one anode comprises an alkali metal.

10. The rechargeable electrochemical cell according to claim 7, wherein the aprotic organic solvent is selected from the group consisting of a polymer, a cyclic ether, a noncyclic ether, a cyclic acetal, a noncyclic acetal, a cyclic organic carbonate and a noncyclic organic carbonate.

11. The rechargeable electrochemical cell according to claim 7, wherein the alkali metal salt is a lithium salt or sodium salt.

12. The rechargeable electrochemical cell according to claim 7, wherein the porous membrane is filled with the electrolyte composition.

13. An alkali metal ion battery comprising at least one rechargeable electrochemical cell according to claim 7.

14. A device comprising at least one rechargeable electrochemical cell according to claim 7.
